(19) United States
(12) Patent Application Publication
(10) Pub. No.: US 2025/0168713 A1
(43) Pub. Date: May 22, 2025

(54) FIRST COMMUNICATION DEVICE, METHOD FOR FIRST COMMUNICATION DEVICE, AND STORAGE MEDIUM

(71) Applicant: NEC Corporation, Minato-ku, Tokyo (JP)

(72) Inventors: Peng SHAO, Tokyo (JP); Atsushi Nakata, Tokyo (JP)

(73) Assignee: NEC Corporation, Minato-ku, Tokyo (JP)

(21) Appl. No.: 18/839,074

(22) PCT Filed: Feb. 6, 2023
(86) PCT No.: PCT/JP2023/003833

§ 371 Date: Aug. 16, 2024

(30) Foreign Application Priority Data
Mar. 30, 2022 (JP) 2022-055429

(51) Int. Cl. H04W 36/00; H04W 36/32

(52) U.S. Cl. CPC H04W 36/00222; H04W 36/322

(57) ABSTRACT

In order to achieve switching control of a communication device with reduced network load, a first communication device acquires an index related to a distance between the first communication device and a terminal device, and determines, when requested for a voice service by the terminal device, whether to switch a communication device that provides the voice service to the terminal device, from the first communication device to a second communication device having a wireless communication scheme different from the first communication device, based on the index.

### TECHNICAL FIELD

The present invention generally relates to a mobile communication network.

### BACKGROUND ART

In recent years, a communication terminal (for example, user equipment (UE)) supporting a plurality of radio access technologies (RATs) such as wideband code division multiple access (W-CDMA, also referred to as 3G), long term evolution (LTE, also referred to as 4G), and new radio (NR, also referred to as 5G) has become widespread. When such a communication terminal requests for provision of a voice service from a network node, a network to which the communication terminal connects may not provide any voice services. In such a case, a network node (for example, a base station) to which the communication terminal connects may switch the network to which the communication terminal connects to a network using a RAT different from the network, and provide a voice service to the communication terminal (fallback).

Processing of the fallback is performed on a network side, but network switching processing or the like may possibly fail on the network side. Thus, PTL 1 describes an invention of storing the number of fallback failures or the like of 4G and 3G cells in past fallbacks in association with location identifiers thereof, and not falling back to a cell that likely fails to fall back.

Further, with current explosive increase of communication terminals, it has become common to use a beamforming technology using a large-scale array antenna included in a base station. Effective use of the beamforming technology enables high-speed and large-capacity wireless communication in NR. For example, in order that a base station divided into CU, DU, and RU performs communication using beamforming, for example, a beamforming technology described in NPL 1 is used.

### CITATION LIST

### Patent Literature

PTL 1: International Publication No. WO2019/071748

### Non Patent Literature

NPL 1: Kazuaki Takeda et al., “Status of Studies on Physical Layer Elemental Technologies and Use of High Frequency Bands in 5G”, NTT DOCOMO Technical Journal, Vol. 25, No. 3, October 2017, <https://www.nttdocomo.co.jp/binary/pdf/corporate/technology/rd/technic al_journal/bn/vol25_3/vol25_3_005jp.pdf>

### SUMMARY OF INVENTION

### Technical Problem

However, in the technique described in PTL 1, fallback control is performed based on a failure record of a failed fallback after an actual fallback attempt, which may possibly increase network load by the time the record is accumulated. This is common for switching of a communication device, including handover as well as fallback.

### Solution to Problem

A communication device according to a first aspect of the present disclosure is a first communication device, and includes: an acquisition means for acquiring an index related to a distance between the first communication device and a terminal device; and a communication switching determination means for determining, when requested for a voice service by the terminal device, whether to switch a communication device that provides the voice service to the terminal device, from the first communication device to a second communication device having a wireless communication scheme different from the first communication device, based on the index.

A method according to the first aspect of the present disclosure is a method to be executed by a first communication device, and includes: acquiring an index related to a distance between the first communication device and a terminal device; and determining, when requested for a voice service by the terminal device, whether to switch a communication device that provides the voice service to the terminal device, from the first communication device to a second communication device having a wireless communication scheme different from the first communication device, based on the index. A program stored in a computer readable storage medium according to the first aspect of the present disclosure causes a first communication device to execute processing of: acquiring an index related to a distance between the first communication device and a terminal device; and determining, when requested for a voice service by the terminal device, whether to switch a communication device that provides the voice service to the terminal device, from the first communication device to a second communication device having a wireless communication scheme different from the first communication device, based on the index.

### Advantageous Effects of Invention

The present disclosure is able to provide a base station, a method, and a storage medium that can achieve switching control of a communication device with reduced network load. Note that, it is to be noted that this advantageous effect is merely one of a plurality of advantageous effects that a plurality of example embodiments disclosed herein seek to achieve. Other advantageous effects will be apparent from the description herein or from the accompanying drawings.

### BRIEF DESCRIPTION OF DRAWINGS

FIG. 1 is an explanatory diagram for describing an example of a network 1 according to a first example embodiment.

FIG. 2 is an explanatory diagram for describing an example of a communication device 2 according to the first example embodiment.

FIG. 3 is an explanatory diagram for describing an example of a communication device 3 according to the first example embodiment.

FIG. 4 is a flowchart for describing an operation example of the communication device 2 according to the first example embodiment.

FIG. 5 is an explanatory diagram for describing an example of a plurality of cells provided by a communication device 7 according to a second example embodiment.

FIG. 6 is an explanatory diagram for describing an example of the communication device 7 according to the second example embodiment.

FIG. 7 is a flowchart for describing an operation example of the communication device 7 according to the second example embodiment.

FIG. 8 is an explanatory diagram for describing an example of a communication device 11 according to a third example embodiment.

FIG. 9 is a sequence diagram for describing an operation example of the communication device 11 according to the third example embodiment.

FIG. 10 is an explanatory diagram for describing an example of a communication device 14 according to a fourth example embodiment.

FIG. 11 is a flowchart for describing an operation example of the communication device 14 according to the fourth example embodiment.

FIG. 12 is an explanatory diagram for describing a configuration example of the communication device 2 or the like according to each example embodiment.

### EXAMPLE EMBODIMENT

Hereinafter, specific example embodiments are described in detail with reference to drawings. In the drawings, same or relevant components are assigned with same reference signs, and duplicated description therefor is omitted as needed for simplification of description.

Example embodiments described below can be carried out independently, or can be carried out in combination as appropriate. The plurality of example embodiments have mutually different novel features. Accordingly, the plurality of example embodiments contribute to solving mutually different objects or problems, and contribute to exhibiting mutually different advantageous effects.

When used herein, “if” may be interpreted as meaning “when”, “at or around the time”, “after”, “upon”, “in response to determining”, “in accordance with a determination”, or “in response to detecting”, depending on a context. The expressions may be interpreted as having the same meaning, depending on a context.

### First Example Embodiment

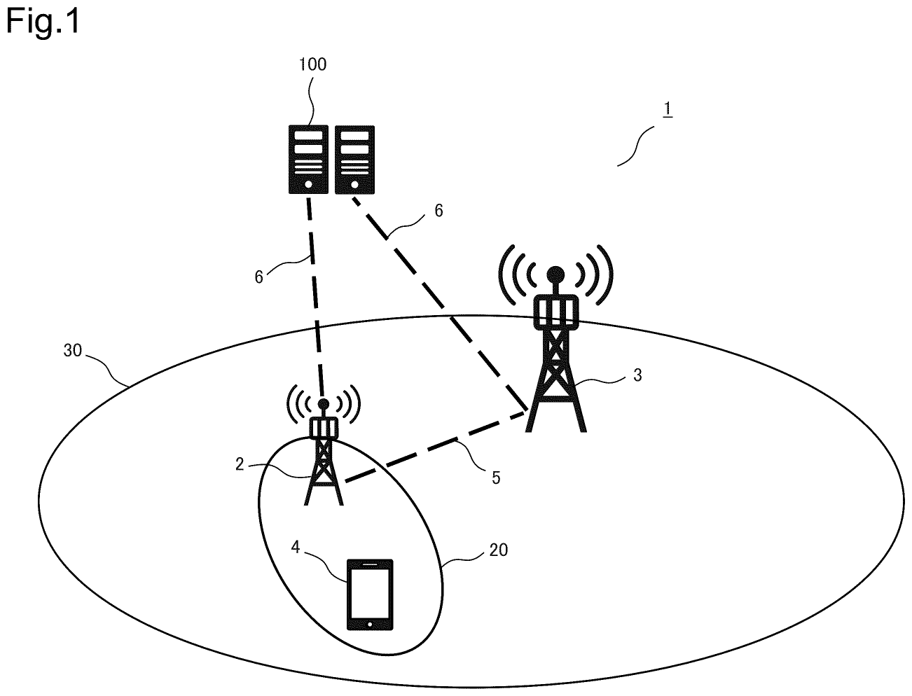

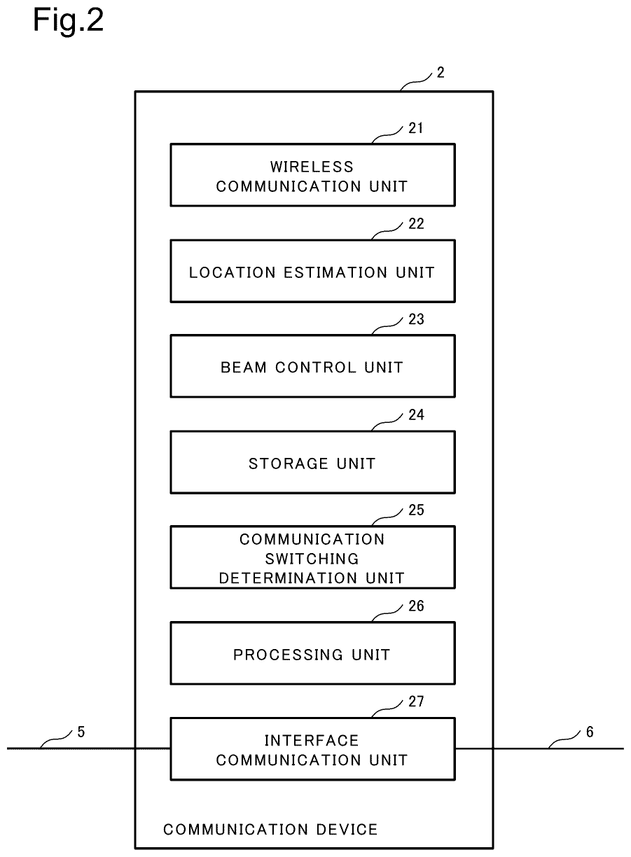

FIG. 1 illustrates a configuration example of a network 1 according to a present example embodiment, and FIG. 2 illustrates a configuration example of a communication device 2 according to the present example embodiment. For example, the communication device 2 and a communication device 3 in FIG. 1 may be a base station supporting a radio access technology or a wireless communication scheme as defined in the Third Generation Partnership Project (3GPP (registered trademark)) such as wideband code division multiple access (W-CDMA), long term evolution (LTE), or new radio (NR). The communication device 2 and the communication device 3 each provide (operate) at least one wireless communication area (cell). In FIG. 1, the communication device 2 provides a cell 20, and the communication device 3 provides a cell 30. The communication device 2 and the communication device 3 may each provide one cell, or may each provide a plurality of cells. When a plurality of cells are present, some or all of the cells may be present in an overlapped way. The communication device 2 and the communication device 3 provide, to a terminal device 4, a communication service conforming to a radio access technology (RAT) that may be different for each communication device. Further, at least one of the communication device 2 and the communication device 3 provides a wireless communication service (including a data communication service and a voice service) to the terminal device 4. The voice service may be, for example, voice over LTE (VOLTE) or voice over NR (VONR).

The communication device 2 and the communication device 3 are connected to each other by an interface 5. The interface 5 may be, for example, an X2 interface or an Xn interface. Further, the communication device 2 and the communication device 3 are connected to a host device 100 by an interface 6. The interface 6 may be, for example, an SI interface or an NG interface, and the host device may be a core network node. Further, the core network node may be a mobile management entity (MME) or an access and mobility management function (AMF).

The number of terminal devices of interest according to the present example embodiment is not particularly limited, and only one terminal device or a plurality of terminal devices may be present. Further, a radio access technology or a wireless communication scheme supported by the communication device 2 and the communication device 3 is not particularly limited, as described above. Hereinafter, for simplicity of description, a case in which there is one terminal device of interest, the communication device 2 is a base station (gNode B, gNB) supporting NR, and the communication device 3 is a base station (evolved node B, eNode B, eNB) supporting LTE is described as one example. Note that, according to the present example embodiment, the communication device 2 serves as a first communication device, and the communication device 3 serves as a second communication device.

In FIG. 2, the communication device 2 includes a wireless communication unit 21, a location estimation unit 22, a beam control unit 23, a storage unit 24, a communication switching determination unit 25, a processing unit 26, and an interface communication unit 27.

The wireless communication unit 21 wirelessly communicates with the terminal device 4 by using beamforming. Further, the wireless communication unit 21 receives, from the terminal device 4, a measurement report relating to a communication environment and a request for a voice service. The measurement report may be a measurement report relating to a communication environment between the terminal device 4 and the communication device 2. Further, the measurement report may be a Measurement Report as defined by the 3GPP. Further, the wireless communication unit 21 may transmit a reference signal to the terminal device 4. The measurement report received from the terminal device 4 may include a measurement result of the reference signal. The reference signal may be a positioning reference signal (PRS) and a sounding reference signal (SRS). The positioning reference signal may be an NR PRS. For example, the measurement report received from the terminal device 4 may include information (cell ID) identifying a cell in which the terminal device 4 camps, reference signal received power (RSRP), reference signal received quality (RSRQ), a value of difference between reference signal received time by the terminal device 4 and reference signal transmitted time by the communication device 2, and channel state information (CSI). Note that, the reference signal may be also called a standard signal.

The location estimation unit 22 estimates a location of the terminal device 4 in the cell of the communication device 2, based on a measurement report received from the terminal device 4. Further, the location estimation unit 22 may save information relating to the estimated location of the terminal device 4 or the measurement report in the storage unit 24. The location estimation unit 22 may estimate, each time the wireless communication unit 21 receives a measurement report, a location of the terminal device 4, based on the measurement report. Alternatively, the location estimation unit 22 may read out a measurement report periodically from the storage unit 24, estimate a location of the terminal device 4, based on the read-out measurement report, and save information relating to the estimated location in the storage unit 24. Further, the location estimation unit 22 may estimate a location of the terminal device 4 when requested for a voice service by the terminal device 4 to be described later.

The location estimation unit 22 may estimate a location of the terminal device 4 by using an NR positioning protocol A (NRPPa) as defined by the 3GPP. When using the NRPPa, the communication device 2 may estimate a location of the terminal 4 in accordance with at least one of an enhanced cell ID (E-cell ID, E-CID) procedure, an NR E-CID procedure, and an observed time difference of arrival (OTDOA) procedure.

When using the NRPPa, the wireless communication unit 21 may transmit a reference signal to the terminal device 4 in response to a request from a core network node connected thereto through the interface 6. The core network node may be a location management function (LMF). The request may be a request for location information using at least one of an enhanced cell ID (E-cell ID, E-CID), an NR E-CID, and an observed time difference of arrival (OTDOA). More specifically, the request may be any of an E-CID measurement initiation request message, an OTDOA information request message, and a positioning information request message.

Further, the location estimation unit 22 may request for location information of the terminal device 4 from a core network node (for example, LMF), receive the location information of the terminal device 4 from the core network node, and estimate a location of the terminal device 4. Further, the location estimation unit 22 may estimate a location of the terminal device 4 by using an LTE positioning protocol (LPP).

The beam control unit 23 controls a beam emission direction and a beam shape (for example, beamwidth), according to a location estimated by the location estimation unit 22.

Specifically, the beam control unit 23 controls a beam emission direction in such a way that an emission direction of a beam emitted from the wireless communication unit 21 is directed in a direction of the terminal device 4. For example, the beam control unit 23 controls a beam emission direction by controlling a phase of a signal emitted from a plurality of antenna elements of an array antenna included in the wireless communication unit 21.

Further, the beam control unit 23 controls a beamwidth in such a way that the longer a distance is between an estimated location of the terminal device 4 and a location of the communication device 2, the narrower the beamwidth becomes. For example, the beam control unit 23 increases the number of antenna elements used for a beam toward the terminal device 4 and narrows a beamwidth as a distance between an estimated location of the terminal device 4 and a location of the communication device 2 increases. Narrowing a beamwidth is equivalent to increasing directivity of a beam and focusing power.

In addition, the beam control unit 23 may provide the number of antenna elements used for a beam for use in communication with the terminal device 4, to the communication switching determination unit 25 to be described later.

The storage unit 24 may save information relating to a location of the terminal device 4 estimated by the location estimation unit 22 or a measurement report.

The communication switching determination unit 25 determines, when requested for a voice service by the terminal device 4, whether to execute switching of a communication device to which the terminal device 4 connects, based on a location of the terminal device 4 estimated by the location estimation unit 22. For example, when a distance between an estimated location of the terminal device 4 and a location of the communication device 2 is equal to or more than a predetermined threshold value, the communication switching determination unit 25 determines to switch a communication device to which the terminal device 4 connects, from the communication device 2 to the communication device 3. For example, when a distance between an estimated location of the terminal device 4 and a location of the communication device 2 is equal to or more than a predetermined threshold value, the terminal device 4 is determined, by the communication device 2, as being located in a cell-edge area of the communication device 2. Note that, a part of a cell excluding a cell-edge area may be hereinafter called a center area. When the switching is performed, the voice service is provided from the communication device 3 to the terminal device 4. Further, when a distance between an estimated location of the terminal device 4 and a location of the communication device 2 is shorter than a predetermined threshold value, the communication switching determination unit 25 determines to keep a communication device to which the terminal device 4 connects as the communication device 2. When the determination is performed, the voice service is provided from the communication device 2 to the terminal device 4. Note that, information relating to a location of the terminal device 4 used for the determination may be read out from the storage unit 24. The information relating to a location read out by the communication switching determination unit 25 may be information relating to a location estimated at a time closest to a time of request for the voice service by the terminal device 4.

Note that, as a parameter representing a distance between a location of the terminal device 4 and a location of the communication device 2, a parameter (for example, the number of antenna elements used to form a beam toward the terminal device 4) influencing on a beamwidth of the communication device 2 toward the terminal device 4 may be used. For example, the communication switching determination unit 25 may acquire, from the beam control unit 23, the number of antenna elements used for a beam toward the terminal device 4, and, when the number of antenna elements is equal to or more than a predetermined threshold value, may determine to switch a communication device to which the terminal device 4 connects, from the communication device 2 to the communication device 3. Further, when the number of antenna elements used for a beam toward the terminal device 4 is less than a predetermined threshold value, the communication switching determination unit 25 may determine to keep a communication device to which the terminal device 4 connects as the communication device 2.

The processing unit 26 performs various kinds of processing in accordance with a determination of the communication switching determination unit 25. For example, when the communication switching determination unit 25 determines to switch a communication device to which the terminal device 4 connects, the processing unit 26 performs processing of switching the communication device. The processing may be, for example, fallback or inter-system handover. The fallback may be, for example, EPS fallback. Examples of a method of achieving the EPS fallback include, for example, handover and redirection, but either may work.

The handover is processing of switching a communication device while keeping connection between the terminal device 4 and a network. The handover may be also referred to as inter radio access technology handover (inter RAT handover). When the communication device 2 is a base station using NR, the communication device 2 communicates with a core network node (for example, an AMF) through the interface 5 to be described later, and carries out, for example, a handover preparation procedure as defined by an NG interface. Thereafter, the communication device 2 carries out a radio resource control (RRC) handover procedure, and connects the terminal device 4 to the communication device 3. In this case, the communication device 3 is a base station using LTE.

The redirection is processing of once disconnecting between the terminal device 4 and a network and thereafter resuming communication at a switching-destination communication device (in this case, the communication device 3) in accordance with a reconnection request (for example, an RRC release procedure and an RRC re-establishment procedure) from the terminal device 4. The redirection may be referred to as RAT fallback.

Further, for example, when the communication switching determination unit 25 determines not to switch a communication device to which the terminal device 4 connects, but to provide a voice service by the communication device 2, the processing unit 26 provides the voice service to the terminal device 4.

The interface communication unit 27 is connected to the communication device 3 through the interface 5. Further, the interface communication unit 27 is connected to a host device through the interface 6. The host device may be a core network node such as a mobile management entity (MME) or an AMF. Further, the interface communication unit 27 communicates with another network node such as the communication device 3 or the host device through various interfaces.

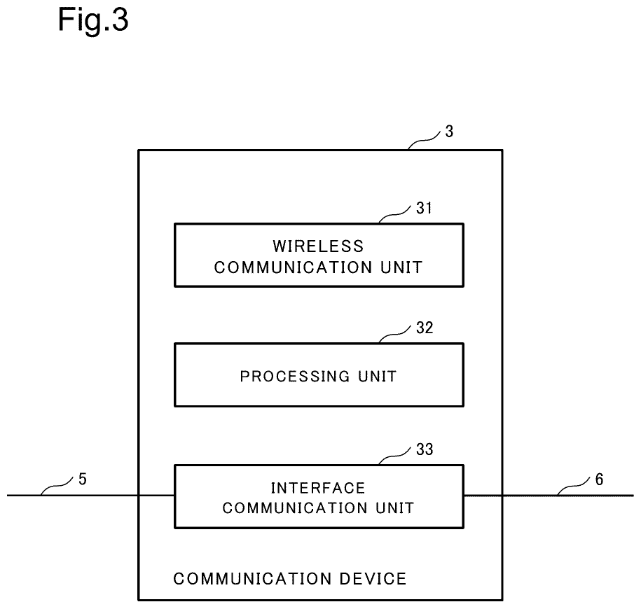

In FIG. 3, the communication device 3 includes a wireless communication unit 31, a processing unit 32, and an interface communication unit 33.

The interface communication unit 33 is configured similarly to the interface communication unit 27 of the communication device 2. The interface communication unit 33 is connected to the communication device 2 through the interface 5, and further, is connected to the host device through the interface 6.

The wireless communication unit 31 connects to the terminal device 4 by the above-described switching (for example, fallback or inter-system handover) of a communication device. The wireless communication unit 31 is connected to and communicates with the terminal device 4 by using a radio access technology. The radio access technology may be LTE or NR.

The processing unit 32 provides a voice service to the terminal device 4 in accordance with a request for provision of the voice service, received from the host device 100. The processing unit 32 may provide a voice service to the terminal device 4 in accordance with a request for provision of the voice service via the host device 100, received from the terminal device 4.

The terminal device 4 transmits a measurement report relating to a communication environment with a communication device, to a communication device to which the terminal device 4 is connected. For example, when the terminal device 4 is connected to the communication device 2, the terminal device 4 may measure a communication environment with the communication device 2 and transmit a measurement report on the communication environment to the communication device 2. In addition, the terminal device 4 may perform measurement relating to a communication environment with the communication device 3 and transmit a measurement report relating to the communication environment with the communication device 3 to the communication device 2 to which the terminal device 4 connects. Further, the terminal device 4 may transmit a measurement report periodically, or may transmit a measurement report for each event. For example, the terminal device 4 may transmit a measurement report to the communication device 2 in response to a request from the communication device 2. Further, the terminal device 4 may transmit a measurement report to the communication device 2 upon receiving a reference signal from the communication device 2. For example, the terminal device 4 may transmit a measurement report to the communication device 2 to which the terminal device 4 connects, each time a connection state between the terminal device 4 and the communication device 2 or a connection state between the terminal device 4 and the communication device 3 changes.

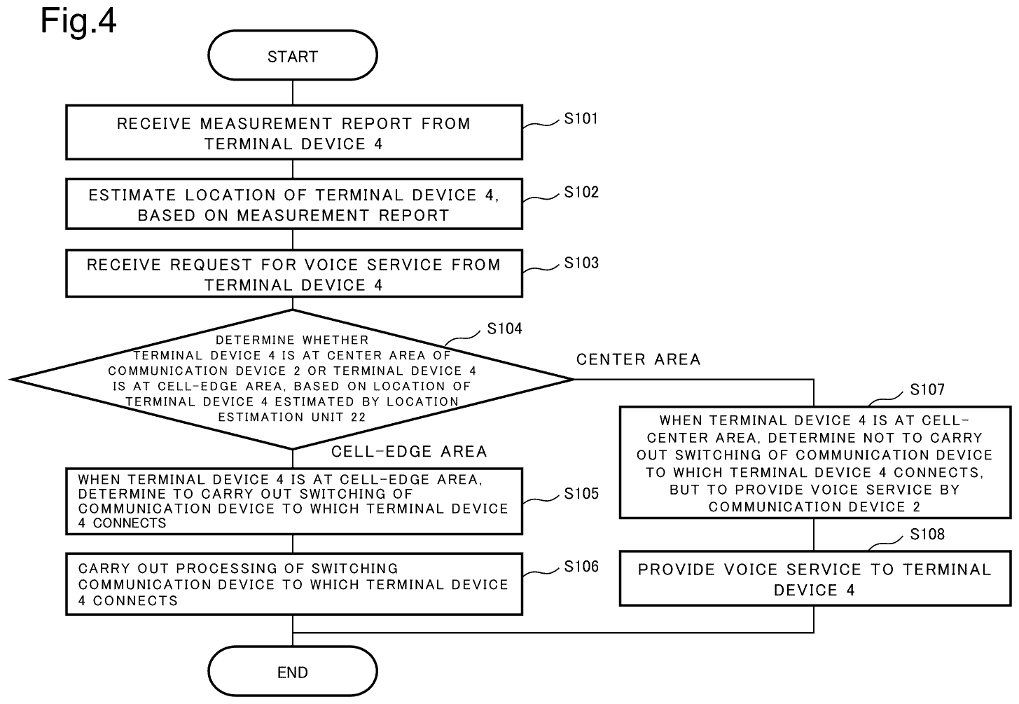

Next, an operation example of the communication device 2 according to the first example embodiment is described by using FIG. 4. FIG. 4 is a flowchart illustrating the operation example of the communication device 2 according to the first example embodiment.

The wireless communication unit 21 of the communication device 2 receives a measurement report from the terminal device 4 (S101). The location estimation unit 22 of the communication device 2 estimates a location of the terminal device 4, based on the measurement report (S102). The wireless communication unit 21 of the communication device 2 receives a request for a voice service from the terminal device 4 (S103). The communication switching determination unit 25 of the communication device 2 determines whether the terminal device 4 is at a center area of the communication device 2 or the terminal device 4 is at a cell-edge area, based on the location of the terminal device 4 estimated by the location estimation unit 22 (S104). When the terminal device 4 is at a cell-edge area, the communication switching determination unit 25 of the communication device 2 determines to carry out switching of a communication device to which the terminal device 4 connects (S105). The processing unit 26 of the communication device 2 carries out processing of switching a communication device to which the terminal device 4 connects (S106). When the terminal device 4 is at a cell-center area, the communication switching determination unit 25 of the communication device 2 determines not to carry out switching of a communication device to which the terminal device 4 connects, but to provide the voice service by the communication device 2 (S107). The processing unit 26 of the communication device 2 provides the voice service to the terminal device 4 (S108).

Naturally, the above-described operations may be carried out independently, or may be carried out in combination as appropriate. The above-described operations allow the communication device 2 to determine switching of a communication device according to a location of the terminal device 4. For example, when the terminal device 4 is at a cell center, switching of a communication device to which the terminal device 4 connects is not carried out, and, when the terminal device 4 is at a cell edge, processing of switching a communication device to which the terminal device 4 connects is carried out. Compared to a terminal device at a center of the cell of the communication device 2, a terminal device at an edge of the cell is considered to be less likely to end up failing in processing of switching to the communication device 3. This is because the terminal device at the edge of the cell of the communication device 2 is considered to be closer to the communication device 3 and to have higher communication quality with the communication device 3 compared to the terminal device at the center of the cell. Accordingly, switching control of a communication device with reduced network load can be performed.

### Second Example Embodiment

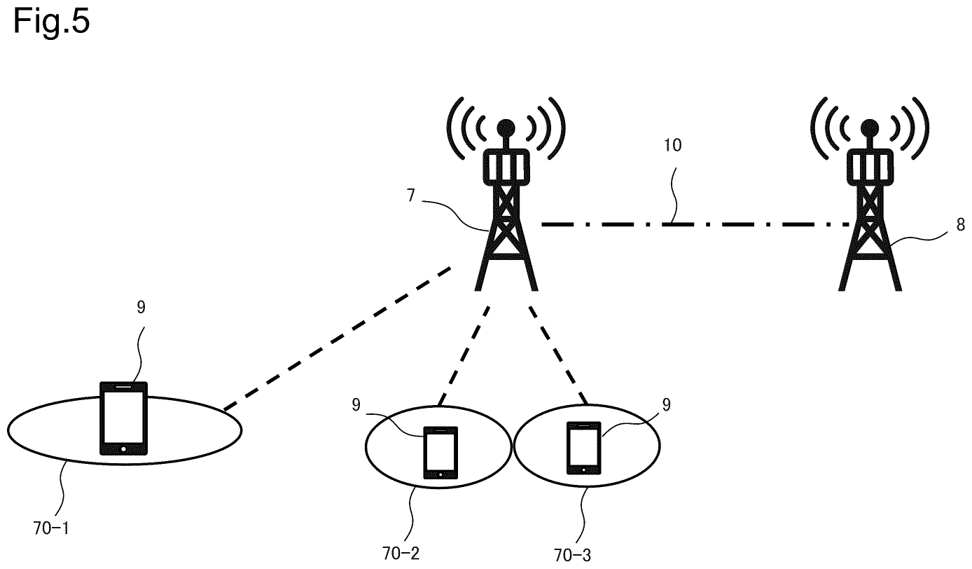

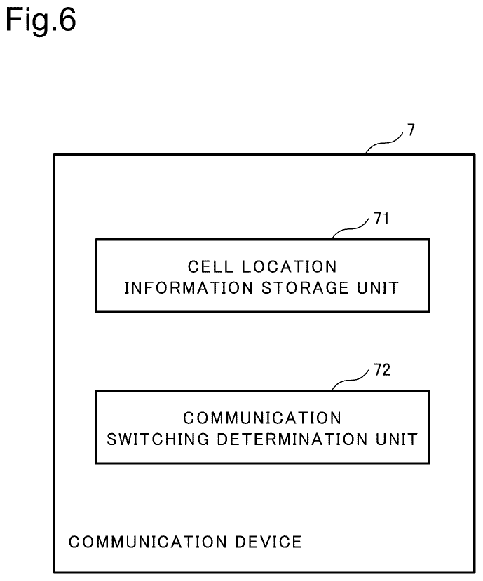

FIG. 5 illustrates an image diagram of a plurality of cells 70-1, 70-2, and 70-3 provided by a communication device 7 according to a present example embodiment, and FIG. 6 illustrates a configuration example of the communication device 7 according to the present example embodiment, respectively. The communication device 7 is equivalent to the communication device 2 according to the first example embodiment, and a communication device 8 is equivalent to the communication device 3 according to the first example embodiment. A terminal device 9 is equivalent to the terminal device 4 according to the first example embodiment. Further, an interface 10 is equivalent to the interface 5 according to the first example embodiment.

In FIG. 6, the communication device 7 includes a cell location information storage unit 71 and a communication switching determination unit 72. The cell location information storage unit 71 stores location information of each of a plurality of cells provided by the communication device 7. The location information may be information indicating a tracking area (TA) to which a cell belongs or information indicating a RAN notification area (RNA), as defined by the 3GPP.

The communication switching determination unit 72 determines, when requested for a voice service by the terminal device 9, whether to execute switching of a communication device to which the terminal device 9 connects, based on a location of a cell in which the terminal device 9 camps. For example, the communication device 7 provides the plurality of cells 70-1, 70-2, and 70-3 at different distances from the communication device 7. Then, when the communication device 7 is requested for a voice service by the terminal device 9, the communication switching determination unit 72 reads out, from the cell location information storage unit 71, information relating to a location of a cell in which the terminal device 9 camps. Then, the communication switching determination unit 72 determines whether to switch a communication device, based on a distance from the communication device 7 of the cell in which the terminal device 9 camps. For example, when a distance between a particular cell and the communication device 7 is equal to or more than a predetermined threshold value, the communication switching determination unit 72 determines not to provide a voice service in the cell. Then, when requested for a voice service by the terminal device 9, the communication switching determination unit 72 determines to change a communication device to which the terminal device 9 connects, from the communication device 7 to the communication device 8. For example, when a distance between a particular cell and the communication device 7 is equal to or less than a predetermined threshold value, the communication switching determination unit 72 determines to provide a voice service in the cell. Then, when requested for a voice service by the terminal device 9, the communication device 7 provides the voice service to the terminal device 9. Note that, the communication switching determination unit 72 may determine whether to switch a communication device for each TA to which a cell belongs and for each RNA. More specifically, the communication switching determination unit 72 may recognize information relating to a location of a TA to which a cell belongs or an RNA and determine switching of a communication device, based on the information relating to a location of a TA or an RNA. Further, the communication switching determination unit 72 may determine in advance whether to switch a communication device for each TA or RNA and determine switching of a communication device, based on the determination.

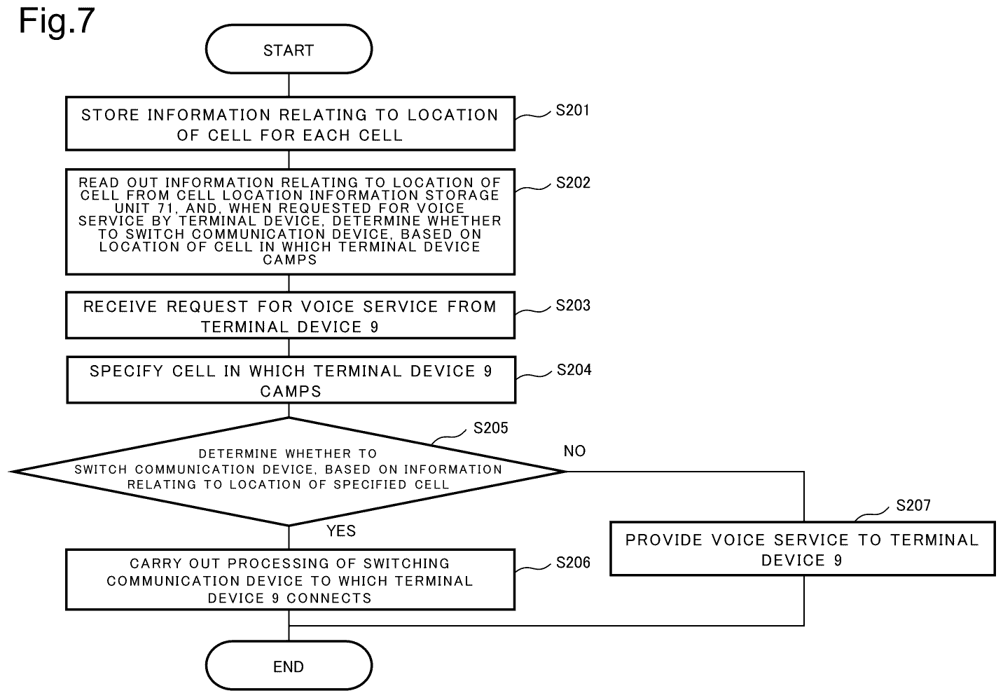

Next, an operation example of the communication device 7 according to the second example embodiment is described by using FIG. 7. FIG. 7 is a flowchart illustrating the operation example of the communication device 7 according to the second example embodiment.

The cell location information storage unit 71 of the communication device 7 stores information relating to a location of a cell for each cell (S201). The communication switching determination unit 72 of the communication device 7 reads out the information relating to a location of a cell from the cell location information storage unit 71, and determines, when requested for a voice service by the terminal device, whether to switch a communication device, based on a location of a cell in which the terminal device camps (S202). The communication device 7 receives a request for a voice service from the terminal device 9 (S203). The communication switching determination unit 72 of the communication device 7 specifies a cell in which the terminal device 9 camps (S204). The communication switching determination unit 72 of the communication device 7 determines whether to switch a communication device, based on information relating to a location of the cell (S205). When switching a communication device (S205, YES), the communication device 7 performs processing of switching a communication device that provides the voice service to the terminal device 9, to the communication device 8 (S206). When not switching a communication device (S205, NO), the communication device 7 provides the voice service to the terminal device 9 (S207).

This allows the communication device 7 to carry out switching of a communication device when the terminal device 4 camps in a cell of a communication device to be switched. Accordingly, it becomes possible to reduce processing load on the communication device 7 associated with switching of a communication device.

### Third Example Embodiment

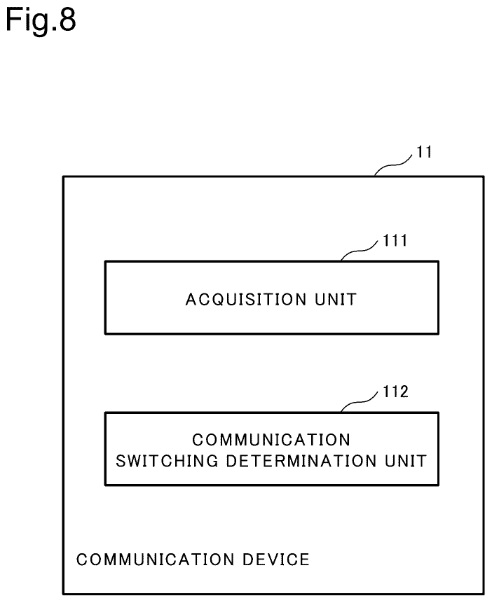

FIG. 8 illustrates a configuration example of a communication device 11 according to a present example embodiment. The communication device 11 is equivalent to the communication device 2 according to the first example embodiment. A communication device 12 described below is equivalent to the communication device 3 according to the first example embodiment. A terminal device 13 described below is equivalent to the terminal device 4 according to the first example embodiment. Note that, the communication device 11 and the communication device 12 may support different wireless communication schemes.

In FIG. 8, the communication device 11 includes an acquisition unit 111 and a communication switching determination unit 112. The acquisition unit 111 acquires, for example, an index related to a distance between the communication device 11 and the terminal device 13. The index related to a distance may be a location of the terminal device 13, or may be a parameter (for example, the number of antenna elements used for a beam toward the terminal device 13) influencing on a beamwidth of the communication device 11 toward the terminal device 13, similarly to the first example embodiment. Alternatively, the index related to a distance may be a location of a cell in which the terminal device 13 camps, similarly to the second example embodiment.

The communication switching determination unit 112 determines, for example, when requested for a voice service by the terminal device 13, whether to switch a communication device that provides the voice service to the terminal device 13, from the communication device 11 to the communication device 12, based on an index acquired by the acquisition unit 111. For example, when the index is relevant to a distance longer than a predetermined threshold value, the communication switching determination unit 112 determines to switch a communication device that provides the voice service to the terminal device 13, from the communication device 11 to the communication device 12. Further, when the index is relevant to a distance equal to or less than a predetermined threshold value, the communication switching determination unit 112 determines not to switch a communication device that provides the voice service to the terminal device 13, from the communication device 11 to the communication device 12, but to keep the communication device 11.

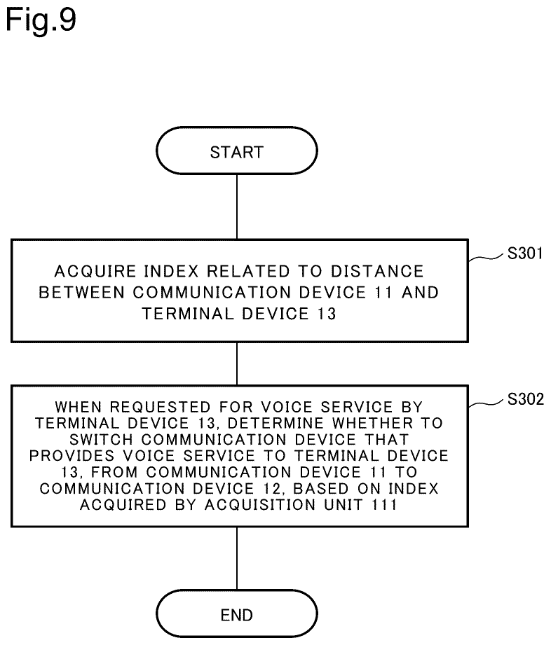

Next, an operation example of the communication device 11 according to the third example embodiment is described by using FIG. 9. FIG. 9 is a sequence diagram illustrating the operation example of the communication device 11 according to the third example embodiment.

The acquisition unit 111 of the communication device 11 acquires an index related to a distance between the communication device 11 and the terminal device 13 (S301). The communication switching determination unit 112 of the communication device 11 determines, when requested for a voice service by the terminal device 13, whether to switch a communication device that provides the voice service to the terminal device 13, from the communication device 11 to the communication device 12, based on the index acquired by the acquisition unit 111 (S302). This allows the communication device 11 to carry out switching of a communication device that provides the voice service to the terminal device 13, based on the index of a distance between the communication device 11 and the terminal device 13. Accordingly, it becomes possible to reduce processing load on the communication device 11 associated with switching of a communication device.

### Fourth Example Embodiment

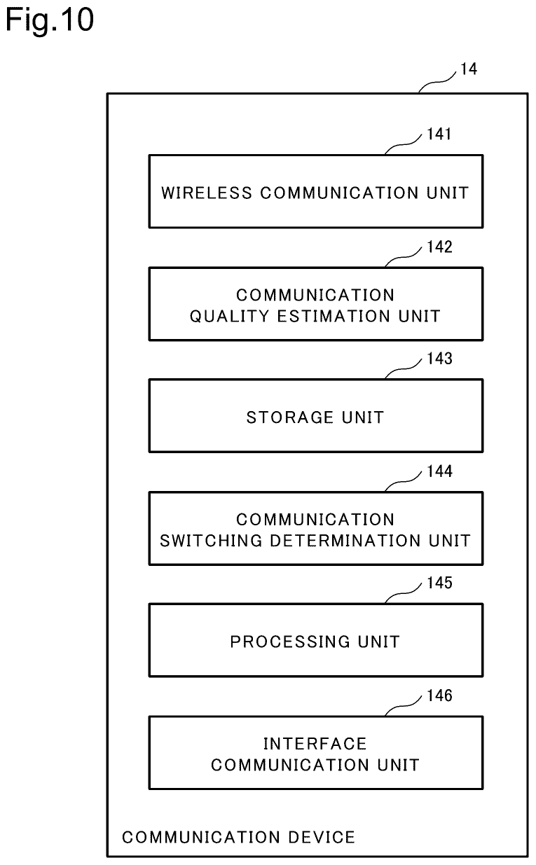

FIG. 10 illustrates a configuration example of a communication device 14 according to a present example embodiment. The communication device 14 is equivalent to the communication device 2 according to the first example embodiment. A communication device 15 described below is equivalent to the communication device 3 according to the first example embodiment. A terminal device 16 described below is equivalent to the terminal device 4 according to the first example embodiment. Hereinafter, for simplicity of description, a case in which there is one terminal device of interest, the communication device 14 is a base station (gNode B, gNB) supporting NR, and the communication device 15 is a base station (evolved node B, eNode B, eNB) supporting LTE is described as one example.

In FIG. 10, the communication device 14 includes a wireless communication unit 141, a communication quality acquisition unit 142, a storage unit 143, a communication switching determination unit 144, a processing unit 145, and an interface communication unit 146.

The wireless communication unit 141 is equivalent to the wireless communication unit 21 of the communication device 2 according to the first example embodiment. The wireless communication unit 141 wirelessly communicates with the terminal device 16 by using beamforming. Further, the wireless communication unit 141 receives, from the terminal device 16, a measurement report relating to a communication environment and a request for a voice service.

The communication quality acquisition unit 142 acquires an “index relating to communication quality of the terminal device 16”. For example, the communication quality acquisition unit 142 may acquire, as the “index relating to communication quality of the terminal device 16”, predetermined information from a measurement report received from the terminal device 16. That is, the communication quality acquisition unit 142 of the communication device 14 may acquire the index on a terminal device basis. Further, the communication quality acquisition unit 142 may acquire the index each time receiving a measurement report from the terminal device 16.

For example, the information that is included in a measurement report received from the terminal device 16 and is acquired by the communication quality acquisition unit 142 as the “index relating to communication quality of the terminal device 16” may be at least one of information (cell ID) identifying a cell in which the terminal device 16 camps, reference signal received power (RSRP), reference signal received quality (RSRQ), a value of difference between reference signal received time by the terminal device 16 and reference signal transmitted time by the communication device 14, and channel state information (CSI).

The storage unit 143 stores at least one of the above-described measurement report and the “index relating to communication quality of the terminal device 16”. When there are a plurality of terminal devices that communicate with the communication device 14, the storage unit 43 may store the above measurement report and the “index relating to communication quality of the terminal device 16” for each of the terminal devices.

The communication switching determination unit 144 determines, when requested for a voice service by the terminal device 16, whether to execute switching of a communication device to which the terminal device 16 connects, for example, based on the “index relating to communication quality of the terminal device 16” acquired by the communication quality acquisition unit 142.

For example, when the “index relating to communication quality of the terminal device 16” indicates communication quality equal to or less than a predetermined level, the communication switching determination unit 144 determines to switch a communication device to which the terminal device 16 connects, from the communication device 14 to the communication device 15. When the switching is performed, the voice service is provided from the communication device 15 to the terminal device 4. For example, when the “index relating to communication quality of the terminal device 16” indicates communication quality equal to or more than a predetermined level, the communication switching determination unit 144 determines to keep a communication device to which the terminal device 16 connects as the communication device 14. For example, when at least one of RSRP and RSRQ of the “index relating to communication quality of the terminal device 16” is equal to or less than a predetermined threshold value, the communication switching determination unit 144 may determine to switch a communication device to which the terminal device 16 connects, from the communication device 14 to the communication device 15. Further, for example, when at least one of RSRP and RSRQ of the “index relating to communication quality of the terminal device 16” is equal to or more than a predetermined threshold value, the communication switching determination unit 144 may determine to keep a communication device to which the terminal device 16 connects as the communication device 14.

The processing unit 145 is equivalent to the processing unit 26 of the communication device 2 according to the first example embodiment. That is, the processing unit 145 performs various kinds of processing in accordance with a determination of the communication switching determination unit 144. For example, when the communication switching determination unit 144 determines to switch a communication device to which the terminal device 16 connects, the processing unit 145 performs processing of switching the communication device. Further, for example, when the communication switching determination unit 144 determines not to switch a communication device to which the terminal device 16 connects, but to provide a voice service to the terminal device 16 by the communication device 14, the processing unit 145 provides the voice service to the terminal device 16. The interface communication unit 146 is configured similarly to the interface communication unit 27 of the communication device 2 according to the first example embodiment. The interface communication unit 146 is connected to the communication device 15 through an interface, and further, is connected to a host device through another interface.

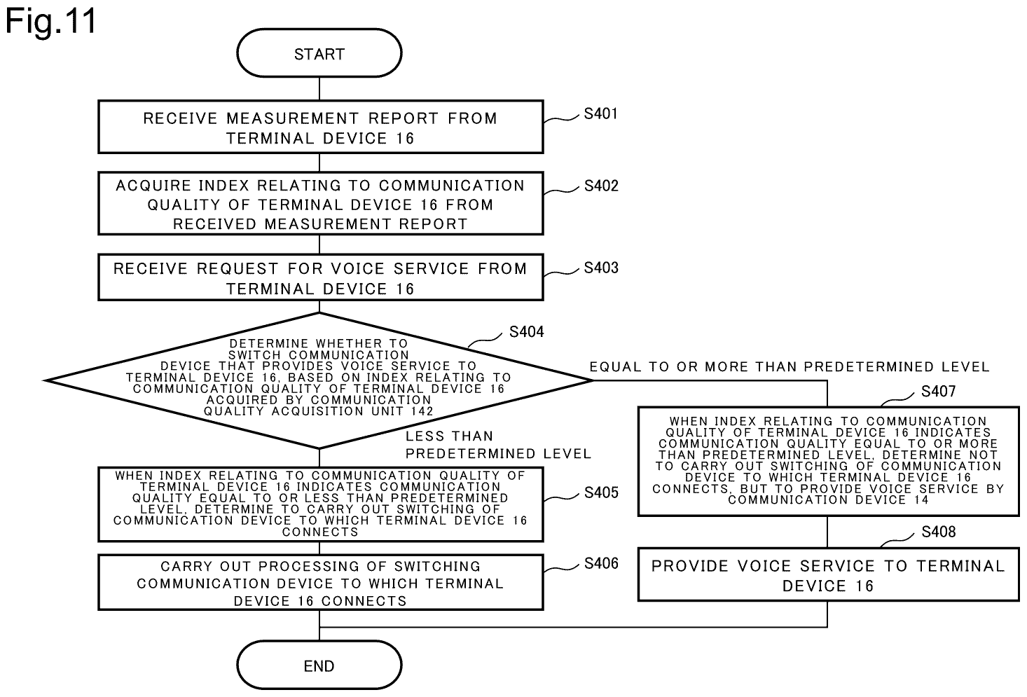

Next, an operation example of the communication device 14 according to the fourth example embodiment is described by using FIG. 11. FIG. 11 is a flowchart illustrating the operation example of the communication device 14 according to the fourth example embodiment.

The wireless communication unit 141 of the communication device 14 receives a measurement report from the terminal device 16 (S401). The communication quality acquisition unit 142 of the communication device 14 acquires an index relating to communication quality of the terminal device 16 from the received measurement report (S402). The wireless communication unit 141 of the communication device 14 receives a request for a voice service from the terminal device 16 (S403). The communication switching determination unit 144 of the communication device 14 determines whether to switch a communication device that provides the voice service to the terminal device 16, based on the index relating to communication quality of the terminal device 16 acquired by the communication quality acquisition unit 142 (S404). When the index relating to communication quality of the terminal device 16 indicates communication quality equal to or less than a predetermined level, the communication switching determination unit 144 of the communication device 14 determines to carry out switching of a communication device to which the terminal device 16 connects (S405). The processing unit 145 of the communication device 14 carries out processing of switching a communication device to which the terminal device 16 connects (S406). When the index relating to communication quality of the terminal device 16 indicates communication quality equal to or more than a predetermined level, the communication switching determination unit 144 of the communication device 14 determines not to carry out switching of a communication device to which the terminal device 16 connects, but to provide the voice service by the communication device 14 (S407). The processing unit 145 of the communication device 14 provides the voice service to the terminal device 16 (S408).

The above-described operations allow the communication device 14 to determine switching of a communication device according to communication quality with the terminal device 16. For example, when communication quality between the terminal device 16 and the communication device 14 is good, switching of a communication device that provides a voice service to the terminal device 16 is not carried out. For example, when communication quality between the terminal device 16 and the communication device 14 is poor, switching of a communication device that provides a voice service to the terminal device 16 is carried out. Thereby, switching control of a communication device with reduced network load can be performed.

### Modified Example of Fourth Example Embodiment

<1> The “index relating to communication quality of the terminal device 16” acquired by the communication quality acquisition unit of the communication device 14 may be the number of wireless reconnections carried out by the terminal device 16 to the communication device 14.

More specifically, the communication quality acquisition unit 142 may acquire the number of wireless reconnections carried out by the terminal device 16 to the communication device 14. The number of wireless reconnections carried out may be, for example, at least one of the number of RRC failure procedures and RRC re-establishment procedures carried out between the communication device 14 and the terminal device 16 and the number of inter-system handovers or fallbacks carried out from the communication device 14 to the communication device 15.

For example, when the above-described number of wireless reconnections carried out is equal to or more than a predetermined threshold value, the communication switching determination unit 144 may determine to switch a communication device to which the terminal device 16 connects, from the communication device 14 to the communication device 15. For example, when the above-described number of wireless reconnections carried out is equal to or less than a predetermined threshold value, the communication switching determination unit 144 may determine to keep a communication device to which the terminal device 16 connects as the communication device 14.
<2> As the above-described “index relating to communication quality of the terminal device 16”, the communication quality acquisition unit 142 may acquire the number of failed inter-system handovers or fallbacks among inter-system handovers or fallbacks previously attempted for the terminal device 16 from the communication device 14 to the communication device 15. Then, for example, when the number of failed inter-system handovers or fallbacks is equal to or less than a predetermined threshold value, the communication switching determination unit 144 may determine to keep a communication device to which the terminal device 16 connects as the communication device 14. For example, when the number of failed inter-system handovers or fallbacks is equal to or more than a predetermined threshold value, the communication switching determination unit 144 may determine to switch a communication device to which the terminal device 16 connects, from the communication device 14 to the communication device 15.
<3> The “index relating to communication quality of the terminal device 16” described above may be used in any combination. For example, the communication switching determination unit 144 may determine whether to switch a communication device to which the terminal device 16 connects, from the communication device 14 to the communication device 15, by using the number of failed inter-system handovers or fallbacks among inter-system handovers or fallbacks previously attempted from the communication device 14 to the communication device 15 in combination with RSRP or RSRQ. For example, when the number of failed inter-system handovers or fallbacks is equal to or more than a predetermined threshold value even when RSRP or RSRQ is equal to or less than a predetermined threshold value, the communication switching determination unit 144 may determine to keep a communication device to which the terminal device 16 connects as the communication device 14.
<4> In the above-described fourth example embodiment and modified example, the communication device 14 acquires an index relating to communication quality with a terminal device on a terminal device basis, and switches a communication device that provides a voice service to the terminal device. Meanwhile, the communication quality acquisition unit 142 may acquire an “index relating to communication quality of a cell”. That is, the communication quality acquisition unit 142 may acquire an index relating to communication quality on a cell basis.

For example, the “index relating to communication quality of a cell” may be a statistically processed “index relating to communication quality of a terminal device” for a plurality of terminal devices. For example, the communication quality acquisition unit 142 may acquire, as the “index relating to communication quality of a cell”, an average value of RSRP or RSRQ included in a measurement report from a plurality of terminal devices that camp in a particular cell. Further, the communication quality acquisition unit 142 may calculate and acquire, as the “index relating to communication quality of a cell”, a total value of the number of wireless reconnections carried out by a plurality of terminal devices in a particular cell.

More specifically, the communication quality acquisition unit 142 of the communication device 14 may acquire and store, in the storage unit 143, an “index relating to communication quality of a terminal device” for a plurality of terminal devices from each of the plurality of terminal devices. Then, the communication quality acquisition unit 142 may read out the “index relating to communication quality of a terminal device” for the plurality of terminal devices from the storage unit 143 and statistically process the index, thereby acquiring the “index relating to communication quality of a cell”. The communication quality acquisition unit 142 may acquire the “index relating to communication quality of a cell” periodically, or may acquire the “index relating to communication quality of a cell” each time the “index relating to communication quality of a terminal device” is updated.

The communication switching determination unit 144 may determine, when requested for a voice service by a terminal device connecting to the communication device 14, whether to switch a communication device to which the terminal device connects, based on the “index relating to communication quality of a cell” acquired by the communication quality acquisition unit 142.

For example, when an average of RSRP or RSRQ included in a measurement report from a plurality of terminal devices that camp in a particular cell is equal to or more than a predetermined threshold value, the communication switching determination unit 144 may determine to keep a communication device to which the terminal device 16 connects as the communication device 14. For example, when an average of RSRP or RSRQ included in a measurement report from a plurality of terminal devices that camp in a particular cell is equal to or less than a predetermined threshold value, the communication switching determination unit 144 may determine to switch a communication device to which the terminal device 16 connects, from the communication device 14 to the communication device 15.

For example, when a total of the number of wireless reconnections carried out by a plurality of terminal devices in a particular cell is equal to or more than a predetermined threshold value, the communication switching determination unit 144 may determine to switch a communication device to which the terminal device 16 connects, from the communication device 14 to the communication device 15.

For example, when a total of the number of wireless reconnections carried out by a plurality of terminal devices in a particular cell is equal to or less than a predetermined threshold value, the communication switching determination unit 144 may determine to keep a communication device to which the terminal device 16 connects as the communication device 14. The above-described operations allow the communication device 14 to determine switching of a communication device according to communication quality of each cell. For example, when communication quality of a cell in which the terminal device 16 camps is good, switching of a communication device that provides the cell and provides a voice service to the terminal device is not carried out. For example, when communication quality of a cell in which the terminal device 16 camps is poor, switching of a communication device that provides a voice service to the terminal device 16 is carried out. Thereby, switching control of a communication device with reduced network load can be performed.

### OTHER EXAMPLE EMBODIMENTS

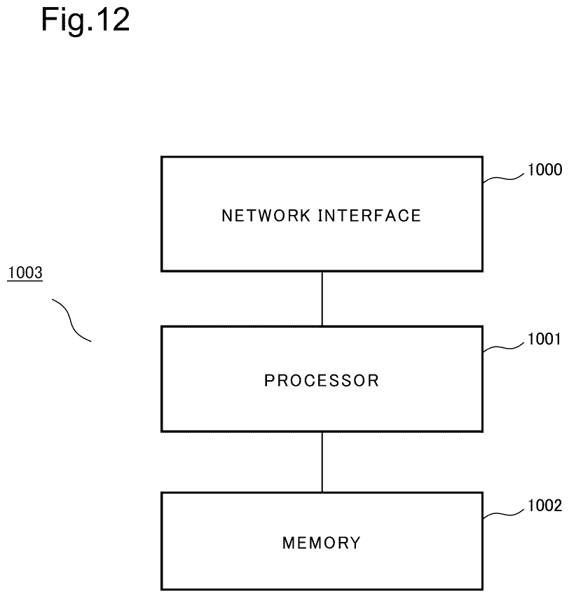

The communication devices 2, 3, 7, 8, 11, 12, 14, and 15 and the terminal devices 4, 9, 13, and 16 (hereinafter, referred to as a communication device 1003 or the like) according to the example embodiment described above may have a hardware configuration as follows. FIG. 12 is a block diagram illustrating a hardware configuration of a computer (information processing device) capable of achieving the communication device according to each example embodiment.

Referring to FIG. 12, the communication device 1003 or the like includes a network interface 1000, a processor 1001, and a memory 1002. The network interface 1000 is used to communicate with another wireless communication device including a plurality of communication terminals. The network interface 1000 may include, for example, a network interface card (NIC) compliant with IEEE 802.11 series, IEEE 802.3 series, or the like.

The processor 1001 reads out from the memory 1002 and executes software (computer program), thereby performing processing of the communication device 1003 or the like described by using the flowchart and the sequence diagram in the above-described example embodiment. The processor 1001 may be, for example, a microprocessor, a micro processing unit (MPU), or a central processing unit (CPU). The processor 1001 may include a plurality of processors.

The memory 1002 is constituted by a combination of a volatile memory and a non-volatile memory. The memory 1002 may include a storage arranged apart from the processor 1001. In this case, the processor 1001 may access the memory 1002 via a not-illustrated I/O interface.

In an example in FIG. 12, the memory 1002 is used to store a group of software modules. The processor 1001 can read out from the memory 1002 and execute the group of software modules, thereby performing processing of the communication device 1003 or the like described in the above-described example embodiment.

As described by using FIG. 12, each of the processors included in the communication device 1003 or the like executes one or a plurality of programs including a group of instructions for causing a computer to perform an algorithm described by using the drawing.

In the above-described example, a program can be stored by using various types of non-transitory computer readable media and supplied to a computer. The non-transitory computer readable media include various types of tangible computer readable storage media. Examples of the non-transitory computer readable medium include a magnetic storage medium (for example, a flexible disk, a magnetic tape, and a hard disk drive) and a magneto-optical storage medium (for example, a magneto-optical disk). Furthermore, examples of the non-transitory computer readable medium include a CD-read only memory (CD-ROM), a CD-R, and CD-R/W. Furthermore, examples of the non-transitory computer readable medium include a semiconductor memory. The semiconductor memory includes, for example, a mask ROM, a programmable ROM (PROM), an erasable PROM (EPROM), a flash ROM, and a random access memory (RAM). Further, a program may be supplied to a computer by various types of transitory computer readable media. Examples of the transitory computer readable medium include an electrical signal, an optical signal, and an electromagnetic wave. The transitory computer readable medium can supply a program to a computer via a wired communication line such as an electric wire and an optical fiber or a wireless communication line.

Note that, the present disclosure is not limited to the above example embodiments, and modifications can be made as appropriate, as long as such modifications do not depart from the gist. Further, the present disclosure may be carried out by combining the example embodiments as appropriate.

For example, the whole or part of the above example embodiments can be described as, but not limited to, the following supplementary notes.

### (Supplementary Note 1)

A first communication device comprising:
an acquisition means for acquiring an index related to a distance between the first communication device and a terminal device; and
a communication switching determination means for determining, when requested for a voice service by the terminal device, whether to switch a communication device that provides the voice service to the terminal device, from the first communication device to a second communication device having a wireless communication scheme different from the first communication device, based on the index.

### (Supplementary Note 2)

The first communication device according to supplementary note 1, wherein
the communication switching determination means determines to switch a communication device that provides the voice service to the terminal device, from the first communication device to the second communication device, when the index is relevant to the distance longer than a predetermined threshold value.

### (Supplementary Note 3)

The first communication device according to supplementary note 2, wherein
the communication switching determination means determines not to switch a communication device that provides the voice service to the terminal device, from the first communication device to the second communication device, but to keep the first communication device, when the index is relevant to the distance equal to or less than the predetermined threshold value.

### (Supplementary Note 4)

The first communication device according to any one of supplementary notes 1 to 3, wherein
the index is a number of antenna elements being used for forming a beam for use in communication with the terminal device.

### (Supplementary Note 5)

The first communication device according to any one of supplementary notes 1 to 3, wherein
the acquisition means includes:
   a wireless communication means for receiving a measurement report from the terminal device; and
   a location estimation means for estimating, as the index, a location of the terminal device from the measurement report.

### (Supplementary Note 6)

The first communication device according to supplementary note 5, wherein
the wireless communication means transmits a reference signal to the terminal device, and receives the measurement report of the reference signal from the terminal device.

### (Supplementary Note 7)

The first communication device according to supplementary note 6, wherein
the reference signal is a positioning reference signal or a sounding reference signal.

### (Supplementary Note 8)

The first communication device according to any one of supplementary notes 6 to 7, wherein
the wireless communication means transmits the reference signal to the terminal device in response to a request from a core network node being connected to the first communication device.

### (Supplementary Note 9)

The first communication device according to any one of supplementary notes 6 to 8, wherein
the measurement report includes at least one of information for identifying a cell in which the terminal device camps, received power of the reference signal, and received quality of the reference signal.

### (Supplementary Note 10)

The first communication device according to any one of supplementary notes 5 to 9, wherein
the measurement report to be transmitted by the terminal device is a Measurement Report.

### (Supplementary Note 11)

The first communication device according to any one of supplementary notes 1 to 10, wherein,
when the communication switching determination means determines to switch a communication device that provides the voice service to the terminal device, from the first communication device to the second communication device, processing of inter-system handover or fallback is performed.

### (Supplementary Note 12)

The first communication device according to supplementary note 11, wherein
the fallback is EPS fallback.

### (Supplementary Note 13)

The first communication device according to any one of supplementary notes 1 to 12, wherein
the first communication device is a base station that supports new radio (NR), and the second communication device is a base station that supports long term evolution (LTE).

### (Supplementary Note 14)

The first communication device according to any one of supplementary notes 1 to 13, wherein
the voice service being provided by the first communication device is voice over NR (VoNR), and the voice service being provided by the second communication device is voice over LTE (VOLTE).

### (Supplementary Note 15)

A method for a first communication device, being executed by the first communication device, the method comprising:
acquiring an index related to a distance between the first communication device and a terminal device; and
determining, when requested for a voice service by the terminal device, whether to switch a communication device that provides the voice service to the terminal device, from the first communication device to a second communication device having a wireless communication scheme different from the first communication device, based on the index.

### (Supplementary Note 16)

A computer readable storage medium storing a program causing a first communication device to execute processing of:
acquiring an index related to a distance between the first communication device and a terminal device; and
determining, when requested for a voice service by the terminal device, whether to switch a communication device that provides the voice service to the terminal device, from the first communication device to a second communication device having a wireless communication scheme different from the first communication device, based on the index.

This application is based upon and claims the benefit of priority from Japanese patent application No. 2022-055429, filed on Mar. 30, 2022, the disclosure of which is incorporated herein in its entirety by reference.

### REFERENCE SIGNS LIST

1 Network
2, 3, 7, 8, 11, 12, 14, 15 Communication device
4, 9, 13, 16 Terminal device
5,6,10 Interface
20 Cell
21 Wireless communication unit
22 Location estimation unit
23 Beam control unit
24 Storage unit
25 Communication switching determination unit
26 Processing unit
27 Interface communication unit
30 Cell
31 Wireless communication unit
32 Processing unit
33 Interface communication unit
70-1, 70-2, 70-3 Cell
71 Cell location information storage unit
72 Communication switching determination unit
111 Acquisition unit
112 Communication switching determination unit
141 Wireless communication unit
142 Communication quality acquisition unit
143 Storage unit
144 Communication switching determination unit
145 Processing unit
146 Interface communication unit
1000 Network interface
1001 Processor
1002 Memory
1003 Communication device

What is claimed is:

1. A first communication device comprising one or more memories storing instructions and one or more processors configured to execute the instructions to:
acquire an index related to a distance between the first communication device and a terminal device; and
determine, when requested for a voice service by the terminal device, whether to switch a communication device that provides the voice service to the terminal device, from the first communication device to a second communication device having a wireless communication scheme different from the first communication device, based on the index.

2. The first communication device according to claim 1, wherein
it is determined to switch a communication device that provides the voice service to the terminal device, from the first communication device to the second communication device, when the index is relevant to the distance longer than a predetermined threshold value.

3. The first communication device according to claim 2, wherein
it is determined not to switch a communication device that provides the voice service to the terminal device, from the first communication device to the second communication device, but to keep the first communication device, when the index is relevant to the distance equal to or less than the predetermined threshold value.

4. The first communication device according to claim 1, wherein
the index is a number of antenna elements being used for forming a beam for use in communication with the terminal device.

5. The first communication device according to claim 1, wherein
the processors are configured to execute the instructions to:
receive a measurement report from the terminal device; and
estimate, as the index, a location of the terminal device from the measurement report.

6. The first communication device according to claim 5, wherein
the processors are configured to execute the instructions to transmit a reference signal to the terminal device, and receive the measurement report of the reference signal from the terminal device.

7. The first communication device according to claim 6, wherein
the reference signal is a positioning reference signal or a sounding reference signal.

8. The first communication device according to claim 6, wherein
the processors are configured to execute the instructions to transmit the reference signal to the terminal device in response to a request from a core network node being connected to the first communication device.

9. The first communication device according to claim 6, wherein
the measurement report includes at least one of information for identifying a cell in which the terminal device camps, received power of the reference signal, and received quality of the reference signal.

10. The first communication device according to claim 5, wherein
the measurement report to be transmitted by the terminal device is a Measurement Report.

11. The first communication device according to claim 1, wherein,
when it is determined to switch a communication device that provides the voice service to the terminal device, from the first communication device to the second communication device, processing of inter-system handover or fallback is performed.

12. The first communication device according to claim 11, wherein
the fallback is EPS fallback.

13. The first communication device according to claim 1, wherein
the first communication device is a base station that supports new radio (NR), and the second communication device is a base station that supports long term evolution (LTE).

14. The first communication device according to claim 1, wherein
the voice service being provided by the first communication device is voice over NR (VoNR), and the voice service being provided by the second communication device is voice over LTE (VOLTE).

15. A method for a first communication device, being executed by the first communication device, the method comprising:
acquiring an index related to a distance between the first communication device and a terminal device; and
determining, when requested for a voice service by the terminal device, whether to switch a communication device that provides the voice service to the terminal device, from the first communication device to a second communication device having a wireless communication scheme different from the first communication device, based on the index.

16. A non-transitory computer readable storage medium storing a program causing a first communication device to execute processing of:
acquiring an index related to a distance between the first communication device and a terminal device; and
determining, when requested for a voice service by the terminal device, whether to switch a communication device that provides the voice service to the terminal device, from the first communication device to a second communication device having a wireless communication scheme different from the first communication device, based on the index.
